(19) United States
(12) Patent Application Publication
(10) Pub. No.: US 2012/0221451 A1
(43) Pub. Date: Aug. 30, 2012

(54) Method and System for a Contract Option

(75) Inventor: Brenda L. Dietrich, Yorktown Heights, NY (US)

(73) Assignee: International Business Machines Corporation, Armonk, NY (US)

(21) Appl. No.: 13/464,458

(22) Filed: May 4, 2012

Related U.S. Application Data
(63) Continuation of application No. 12/348,082, filed on Jan. 2, 2009.

(51) Int. Cl. G06Q 40/00

(52) U.S. Cl. 705/35

(57) ABSTRACT

This invention provides a novel method and system for instantiating a data structure comprising a contract option including a disjunctive capability, of especial utility in enabling a new way of selling commodities or services. Rather than being a right to buy a unit of a type of item at a specified price, as is known to the prior art, the present invention enables one to secure a right to buy at least one unit of one of n-types of items at a predetermined legal consideration.

### BACKGROUND OF THE INVENTION

1. Field of the Invention

This invention relates to a novel method and system for instantiating a data structure comprising a contract option including a disjunctive capability, of especial utility in enabling a new way of selling products or services.

2. Introduction to the Invention

Contract options are known, and include a right to buy a unit of a specific item type at a specific price at some future time. Generally, an option may be purchased for a relatively small price, called here the option price, and the item may be purchased for a specified price, called the item price or (in the case of stock options) strike price.

In particular, and, for example, bundled options are currently used in financial markets. A maximum option includes a bundle of options with a variety of features including different underliers and different strike prices. Only one of the options in the bundle can be exercised, and that one is chosen in the holder's favor at expiration. A minimum option is similar, except that the option to be exercised is chosen in the issuer's favor at expiration. Because of the liquidity of the financial markets, and that fact the underlying instruments can be turned (bought and resold) instantaneously, or exchanged instantly for cash at market value with no loss of utility, there is only a very weak notion of “supply” or “capacity”. If one sells more options on a stock than one has actual shares, the value of the options can still be delivered to the buyers. Issuing and pricing such options requires modeling and analyzing the relationship between price and demand, and analyzing the dynamics and variability of the financial markets and/or the underlying instruments, but does not require consideration of the availability of a limited supply of the items under consideration.

In sharp contrast, physical goods and services are actually consumed by the purchaser. They are bought for a purpose other than simple financial gain. Thus, when selling options for physical goods or services, one must also consider the available supply and the various methods of using that supply to fulfill the options that have been sold. Thus, the supporting data systems and information systems that support the sale of bundled financial options can not be directly applied to the sales and fulfillment processes associated with disjunctive options for physical goods or services. Further, existing inventory and resource management systems tie each sale to specific items (part numbers, SKUs, flights, etc) and use only simple addition and subtraction to avoid depleting supplies. These systems can not effectively represent the sale of even simple options (as opposed to sale of items), and thus can not represent or aid in managing the sale of disjunctive options. Finally, as the intent of financial options is purely to manage financial exposure or gain, rather than to provide flexibility in the use of physical resources such as goods, or resources used to provide services, it is not obvious that the more complex options used in financial markets would have a meaningful application to physical goods and services.

### SUMMARY OF THE INVENTION

The present invention discloses a new type of contract option.

In overview, the present invention enables one to secure a right to buy at least one unit of one of n-types of items at a specified legal consideration. This capability is in sharp contrast to the prior art, which consists simply in defining a contract option as one being a right to buy a unit of a specific type of item at a specified price.

Accordingly, in a first aspect of the present invention, there is disclosed a data structure comprising a contract option, the contract option including a disjunctive capability providing the right to buy at least one unit of at least one of n-types of items at a predetermined consideration, the contract option providing an ability to actually meet, with existing resources, all the obligations of options that may be sold.

Preferably, the disjunctive capability comprises at least one of a buyer preference form and a seller preference form. For example, the buyer preference form may comprise a buyer capability for deciding for some time after the purchase of an option which of the types of items will be purchased. In an analogous way, the seller preference form may comprise a seller capability for deciding at some time after the purchase of an option which of the types of items will be sold to a buyer. Note that the disjunctive capability preferably may include a case wherein the buyer preference form and the seller preference form are used in combination.

The predetermined legal consideration recited above typically includes a specified price of an item.

Note that the aforementioned contract option can be enabled at some future time.

In a second aspect of the present invention, there is disclosed a method comprising the steps of:

i) instantiating a data structure comprising a contract option, said contract option including a disjunctive capability providing a right to buy at least one unit of at least one of n-types of items at a predetermined consideration, the contract option providing an ability to actually meet, with existing resources, all the obligations of options that may be sold;

and

ii) offering said contract option to at least one buyer.

In a third aspect of the present invention, there is disclosed a method comprising the steps of:

i) instantiating a data structure comprising a contract option, said contract option including a disjunctive capability providing a right to buy at least one unit of at least one of n-types of items at a predetermined consideration, the contract option providing an ability to actually meet, with existing resources, all the obligations of options that may be sold;

and

ii) offering said contract option to at least one seller as a solicitation from a buyer.

In a fourth aspect of the present invention, there is disclosed a computer system especially configured for enabling a novel way of selling products and/or services, the computer system comprising:

i) means for instantiating a data structure comprising a contract option, said contract option including a disjunctive capability providing a right to buy at least one unit of at least one of n-types of items at a predetermined consideration, the contract option providing an ability to actually meet, with existing resources, all the obligations of options that may be sold;

ii) means for inputting information to the data structure for execution of a particular contract option;

and

iii) means for operating upon and executing said contract option with respect to said input information for outputting a specific contract option.

The present invention, as just illustratively defined in four summarized aspects, can provide inherent novel advantages compared to the prior art, since new contract option capabilities may now be realized.

Further advantage of the present invention may be realized because it may be exploited in many disparate fields, for example, extending from financial markets, to the airline industry, or to advertising media (commercial timeslots on TV). In this last case, for example, a high paying buyer might want options for many timeslots, and by way of the present invention, being enabled to choose which timeslot to use based on viewership and/or events that may impact viewership. Other application areas include professional services e.g., contracting for a lawyer, surgeon, or programmer, etc. For example, for some key court cases/operations/projects one might want to reserve multiple resources and decide which to use close to the time of need depending on how other circumstances play out. For less critical court cases/operations/projects, one might be willing to pay less and take whatever gets provided.

Other advantages may also be secured, since the present invention sets forth a novel contract option framework that can be readily adapted to add more functionality, for example, determining how many options to offer, or what option price or purchase price to offer.

### BRIEF DESCRIPTION OF THE DRAWING

The invention is illustrated in the accompanying drawing, in which:

FIG. 1 provides a flowchart realizing a methodology of the present invention; and

FIG. 2 shows an environment for machine realization of the present invention.

### DETAILED DESCRIPTION OF THE INVENTION

The present invention, as summarized above, is now illustratively enabled pursuant to the following detailed description.

Preferred enablement of the present invention assumes that there must be at least one item of each type available; in general, we expect that a form of options that this will be most applicable will obtain when multiple items of each type are available. We call this a disjunctive option, as in a simplest case one, the option is a right to buy either A or B (but not necessarily both) at a specified price.

For the purpose of illustration, we use an example from the airline industry. However, this invention is not limited to this example, but is applicable to any circumstance where buyers purchase one item from among a collection of different types of items.

In our example, the seller is an airline and the buyers are passengers. The items being purchased are seats on the direct flights from city A to city B. We note that a traveler generally has some desired time window for departure, and in the case when multiple airports serve a city, may have a preference for at least one of the departure airport and the arrival airport. A disjunctive option would be the right to buy a ticket on one of a specified set of flights (or equivalently, to fly) in the desired time window from city A to city B. For our example, we assume that the full fare from city A to B is $700 and that the lowest price fare is $200. Note that the purchase price may depend on which flight is used, but is locked in at the time the option is purchased.

Preferably, there are two forms of disjunctive options, the buyer preference (BP) form in which the buyer can decide at some time after the purchase of the option, which one of the types of items he will purchase, and the seller preference (SP) form, in which the seller may decide at some time after the purchase of the option, which one of the types of items he will sell to the buyer.

In our example, the BP option gives the passenger the right to fly on any of the specified flights while the SP option gives the passenger the right to fly on (at least) one of the specified flights. The BP option might be attractive to a business traveler, who is planning to take the 6 pm flight, but wants to have the flexibility to extend his meeting and catch the 7 pm flight. The business traveler might buy this option for $300, with a ticket purchase price of $700. His total cost to fly is then $1000, which is more than the cost of a single ticket but less that the cost of tickets on both flights. The SP option might be attractive to a college student who has a limited budget, and is willing to arrive at the airport in time for the 6 pm flight with the understanding that he might have to wait for the 7 pm flight. He might buy this option for $50, with a ticket price of $100. His total cost to fly is then $150, which is less than the lowest cost fare.

Using BP and SP disjunctive options in combination may provide particular benefit. In our example, suppose that the airline had exactly one seat available on each of the two flights. If both the business traveler and the student purchased the options and tickets as described above, the airline's revenue would be $1150. Although this is less than the maximum $1400 possible revenue for these two tickets, it is considerably higher than the revenue that would have been generated had either of the seats remained empty.

The BP disjunctive option provides significant flexibility to the buyer. One would expect that these would normally carry a premium price. Essentially the buyer is reserving multiple items (one of each type). One might expect that the item price for such an option would be at or near the list price of the item, and that the option price would be at least a significant fraction of the list price. Thus the total cost of exercising such options would be priced at a level that would be higher than the usual price of a single item of any type, but lower than the sum of the usual price of one item of each type.

The SP disjunctive option provides significant flexibility to the seller. He can continue to offer the optioned items for sale at a higher price, so long as he has access to more items (of each type) than he has sold options for.

It should be noted that when used in combination, BP and SP disjunctive options provide a means for sellers to generate additional revenue by providing flexibility to their high value customers while generating a simultaneous demand for the resulting surplus.

The challenge of using disjunctive options is that since there is no longer a one-to-one relationship between options and types of items, it is no longer straight forward for the seller to determine whether he has sufficient capacity to meet all of the options he has sold, or even whether he has sufficient capacity to sell one more option. In general, this “feasibility determination” problem requires computing an allocation of the individual items to the option owners. In the case of combinations of BP and SP disjunctive options, it requires considering (implicitly or explicitly) every possible combination of type choices of the buyers.

In the simplest embodiment of flexible options the available item types are partitioned into disjoint sets, and a disjunctive option gives a buyer the right to buy one unit of one of the items in the set. In our airline example, the sets might be

Set1={7 am flight, 8 am flight}

Set2={9 am flight, 10 am flight, 11 am flight}

Set3={12 noon flight, 1 pm flight, 2 pm flight}

Set4={3 pm flight, 4 pm flight}

Set5={5 pm flight, 6 pm flight, 7 pm flight}

Set6={8 pm flight, 9 pm flight,}.

Note that it is not necessary for the sets to be of the same size. To ensure feasibility, the number of items of each type must be at least as large as the number of BP options sold for the set that includes that type. Further, the total number of items in the types in a set must be at least as large as the total number of BP and SP options sold for that set. Thus, rather than just checking, on whether there is remaining availability of a single item, when selling a single disjunctive option, one must compute several values, and evaluate inequalities involving all of these values.

In the airline example, feasibility requires that the number of available seats on a flight must be at least as large as the number of BP options sold for the set that includes that flight. Further, the total number of seats available on the flights in a set must be at least as large as the total number of BP and SP options sold for that set.

Additional flexibility can be obtained by allowing the sets to have items in common. However, this makes the problem of determining availability somewhat more complex. S(2), . . . , S(n) be the sets for which disjunctive options are being sold and let q(i) be the m of options sold for set S(i), I=1, . . . , n. For item type t, let a(t) be the number of items of available. Then for each type t, the sum of number of BP options sold for sets that include cannot exceed the number of units available for type t.

That is,

$$a ( t ) \geq {\sum }_{t ∈ S ( i )}^{ } q ( i ) for all t . \qquad ( 1 )$$

If only SP options are sold, a combination q(1), q(2), . . . q(n) of q(i) SP options for set S(i) is feasible if and only if there is an integer solution to the following set of equations.

$$\begin{matrix}{\sum }_{i ∋ t ∈ S ( i )}^{ } y ( i , t ) \leq a ( t ) for all t & ( 2 ) \\ {\sum }_{i ∋ t ∈ S ( i )}^{ } y ( i , t ) = q ( i ) & ( 3 ) \\ y ( i , t ) \geq 0 , integer & ( 4 )\end{matrix}$$

In the equations above, y(i,t) is the number of SP options for set S(i) that are satisfied by items of type t.

We observe that although some for some instances of the sets S(i) it may be relatively easy to determine whether integers y(i,t) satisfying the equations (2)-(4) is in general quite difficult. In fact, even in the case when a feasible solution y*(i,t) exists, determining whether another SP option for set i can be sold is also quite difficult if

$${\sum }_{t}^{ } {y}^{*} ( i , t ) = a ( t ) .$$

A technique known as integer programming can be used to solve both the feasibility problem and the incremental feasibility problem.

When both BP and SP options are being sold for the same set of items, determining feasibility requires that for every possible set of buyer choices of eligible items, there be enough remaining items to satisfy all of the seller choice options. We let q^{BP}(i) be the number of buyer preference options for set i, q^{SP}(i) and be the number of buyer preference options for set φ. It is sufficient, but not necessary that there is an integer solution to the following set of equations.

$$\begin{matrix}{\sum }_{i ∋ t ∈ S ( i )}^{ } {y}^{SP} ( i , t ) \leq a ( t ) - {\sum }_{t ∈ S ( i )}^{ } {q}^{BP} ( i ) for all t & ( 5 ) \\ {\sum }_{i ∋ t ∈ S ( i )}^{ } {y}^{SP} ( i , t ) = {q}^{SP} ( i ) & ( 6 ) \\ {y}^{SP} ( i , t ) \geq 0 , integer & ( 7 )\end{matrix}$$

This approach to determining feasibility is very conservative; essentially it reserves an excessive number of items for the buyer choice options. Additional seller choice options can be sold to generate revenue from the items that must be available for, but will not be consumed by, the buyer choice options. Let s(i,t) be integers such that

$$\begin{matrix}{\sum }_{i ∋ t ∈ S ( i )}^{ } s ( i , t ) \leq a ( t ) for all t & ( 8 ) \\ {\sum }_{i ∋ t ∈ S ( i )}^{ } s ( i , t ) = {q}^{BP} ( i ) & ( 9 ) \\ s ( i , t ) \geq 0 , integer & ( 10 )\end{matrix}$$

We can interpret s(i,t) as the number of buyers of a BP option for set S(i) who select type t. Then the combination of q^{BP}(i) buyer preference options and q^{SP}(i) seller options of type i=1,2, . . . , n is feasible if and only if for every set of integers s(i,t) satisfying equations (8)-(10) there exists a set of integers the following set of equations.

$$\begin{matrix}{\sum }_{i ∋ t ∈ S ( i )}^{ } {y}^{SP} ( i , t ) \leq a ( t ) - {\sum }_{i}^{ } {\sum }_{t ∈ S ( i )}^{ } s ( i , t ) for all t & ( 11 ) \\ {\sum }_{i ∋ t ∈ S ( i )}^{ } {y}^{SP} ( i , t ) = {q}^{SP} ( i ) & ( 12 ) \\ {y}^{SP} ( i , t ) \geq 0 , integer & ( 13 )\end{matrix}$$

For each possible allocation s(i,t), a technique known as integer programming can be used to determine whether a feasible solution to (11)-(13) exists. The incremental availability check can also be made using integer programming.

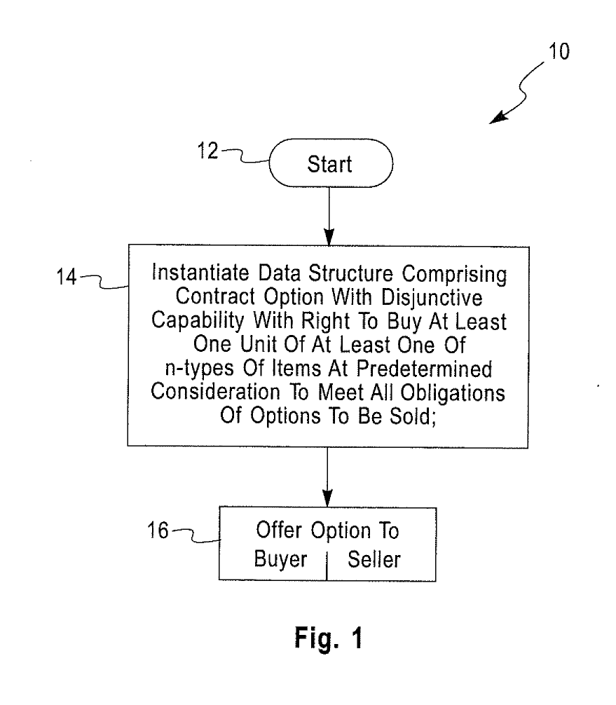

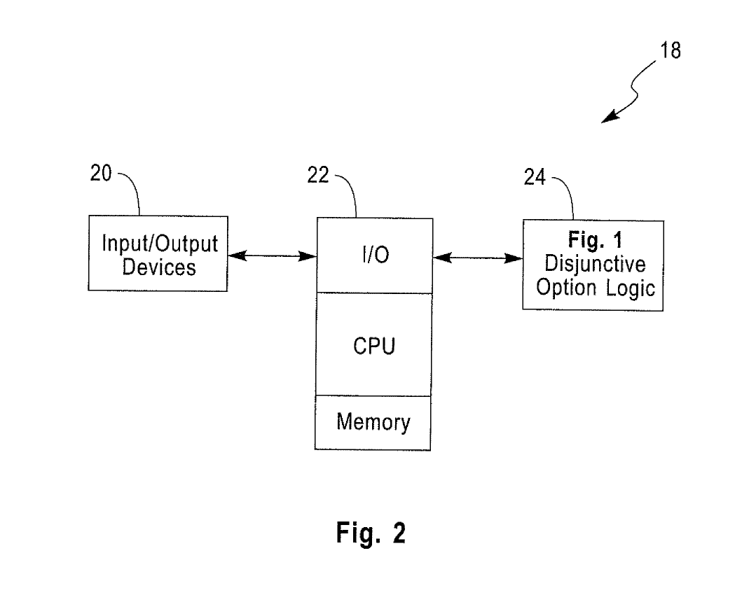

Attention is now directed to FIGS. 1 and 2, which show respectively, a flowchart (numerals 10-16) for enablement of a representative aspect of the present invention, and a block diagram illustrating an exemplary computer system (as numeral 18-24) for machine realization of the present invention. In particular, the computer system 18 comprises means for instantiating a data structure comprising a contract option, the contract option including a disjunctive capability providing a right to buy at least one unit of at least one of n-types of items at a predetermined consideration, the contract option providing an ability to actually meet, with existing resources, all the obligations of options that may be sold; means for inputting information to the data structure for execution of a particular contract option; and means for operating upon and executing the contract option with respect to the input information for outputting a specific contract option.

1-7. (canceled)

8. A method comprising the steps of:
providing, in a computer system that comprises a memory, a resource data identifying a seller's resource, said resource being a plurality of item types and a quantity of units of each item type;
i) instantiating, performed by the computer system, a plurality of different forms of buyer-preference option sets and, for each of said different forms, and an associated quantity of buyer-preference option sets of each form, each buyer-preference option set consisting of a plurality of different item types from among said item types, said plurality specified by said form; and
ii) offering, performed by the computer-system, buyer-preference disjunctive option contracts corresponding to said buyer-preference option sets, each of said buyer-preference disjunctive option contracts representing a buyer's disjunctive right to select, at a future time, any one item type from among the item types within a buyer-preference option set identified by the contract, and representing the buyer's right to buy at least one unit of the buyer's selected item type, at a predetermined consideration,
wherein said instantiating said forms and said associated quantities includes, and is subject to, determining a feasibility, wherein the determining a feasibility indicates the seller resources represented by the resource data are sufficient to meet all possible combinations of all buyers' disjunctive selection and buying rights represented by the concurrent existence of all of said plurality of buyer-preference option contracts.

9-13. (canceled)

14. The method of claim 8, wherein each of said item types is an air travel flight/time reservation,
wherein said resource data identifies an available quantity of each of a plurality of different air travel flight/time reservations,
wherein each of said buyer-preference option sets is a set of different air travel flight/time reservations from among said plurality of item types, and
wherein said buyer's disjunctive right is a right to select, at a future time, any from the different air travel flight/time reservations within the buyer-preference options set identified by the disjunctive option contract, and to use a quantity of at least one seat corresponding to the buyer's selected air travel flight/time reservation.

15. The method of claim 8, wherein
said instantiating further includes instantiating a plurality of different forms of seller-preference option sets and, for each of said different forms, an associated quantity of seller-preference option sets of each form, each seller-preference option set consisting of a plurality of different item types from among said item types, said plurality specified by said form, and
wherein said offering further includes offering seller-preference disjunctive option contracts corresponding to said seller-preference option sets, each of said seller-preference disjunctive option contracts representing a seller's disjunctive obligation to select, at a future time, any one item type from among the item types within a seller-preference option set identified by the contract, and representing the buyer's right to buy at least one unit of the seller's selected item type, at a predetermined consideration, and
wherein said determining a feasibility includes determining that the seller resources represented by the resource data are sufficient to meet all possible combinations of all buyers' disjunctive selection and buying rights represented by the concurrent existence of all of said plurality of buyer-preference option contracts and, concurrently, are sufficient to meet the total seller's obligation arising from a concurrent existence of all of said plurality of seller-preference disjunctive option contracts.

16. The method of claim 15, wherein said resource data identifies an available quantity of each of a plurality of different air travel flight/time reservations,
wherein each of said buyer-preference options sets and each of said seller-preference option sets is a set of different air travel flight/time reservations from among said plurality of item types,
wherein said buyer's disjunctive right is a right to select, at a future time, any from the different air travel flight/time reservations within the buyer-preference options set identified by the disjunctive option contract, and to use a quantity of at least one seat corresponding to the buyer's selected air travel flight/time reservation,
said seller obligation is an obligation by the seller to select, at a future time, any from the different air travel flight/time reservations within the seller-preference options set identified by the seller-preference disjunctive option contract, and to sell a quantity of at least one seat corresponding to the sellers selected air travel flight/time reservation.

17. A method comprising:
providing, in a computer system that comprises a memory, a resource data identifying a seller's resource, said resource being a plurality of item types and a quantity of units of each item type;
instantiating, performed by the computer system, a plurality of different forms of seller-preference option sets and, for each of said different forms, and an associated quantity of seller-preference option sets of each form, each buyer-preference option set consisting of a plurality of different item types from among said item types, said plurality specified by said form; and
offering, performed by the computer system, seller-preference disjunctive option contracts corresponding to said seller-preference option sets, each of said seller-preference disjunctive option contracts representing a seller's disjunctive obligation to select, at a future time, any one item type from among the item types within a seller-preference option set identified by the contract, and representing the buyer's right to buy at least one unit of the seller's selected item type, at a predetermined consideration,
wherein said instantiating said forms and said associated quantities includes, and is subject to, determining a feasibility, wherein the determining a feasibility indicates the seller resources represented by the resource data are sufficient to meet the total seller's obligation arising from a concurrent existence of all of said plurality of seller-preference disjunctive option contracts.

18. The method of claim 8, wherein said providing a resource data represents the data as a(t) being the number of units of type t that are available, and wherein said instantiating and said feasibility-determining comprise computing the following algorithm:
$$a ( t ) \geq {\sum }_{t ∈ S ( i )}^{ } q ( i ) for all t .$$
S(1), S(2), . . . S(N) represent a plurality of N of said instantiated forms; and
q(i) represents the associated quantity of buyer-preference option sets instantiated having the form S(i).

19. The method of claim 17, wherein said providing a resource data represents the data as a(t) being the number of units of type t that are available, and wherein said instantiating and said feasibility-determining comprise computing the following algorithm:
$$\begin{matrix}{\sum }_{i ∋ / ∈ S ( i )}^{ } y ( i , t ) \leq a ( t ) for all t \\ {\sum }_{i ∋ / ∈ S ( i )}^{ } y ( i , t ) = q ( i ) \\ y ( i , t ) \geq 0 , integer\end{matrix}$$
where,
S(1), S(2), . . . S(N) represent a plurality of N of said instantiated forms,
q(i) represents the associated quantity of buyer-preference option sets instantiated having the form S(i), and
y(i,t) is the quantity of seller-preference option contracts for set S(i) that are satisfied by items of type t.

20. The method of claim 15, wherein said providing a resource data represents the data as a(t) being the number of units of type t that are available, and wherein said instantiating and said feasibility-determining comprise computing the following algorithm:
$$\begin{matrix}{\sum }_{i ∋ / ∈ S ( i )}^{ } {y}^{SP} ( i , t ) \leq a ( t ) - {\sum }_{t ∈ S ( i )}^{ } {q}^{BP} ( i ) for all t \\ {\sum }_{i ∋ / ∈ S ( i )}^{ } {y}^{SP} ( i , t ) = {q}^{SP} ( i ) \\ {y}^{SP} ( i , t ) \geq 0 , integer\end{matrix}$$
where
S(1), S(2) . . . S(R) are each a buyer-preference option set or a seller-preference option set of R different of the item types,
y^{SP}(i,t) is the number of seller-preference option contracts for set S(i) that are satisfied by items of type t, and
q^{BP}(i) is the number of buyer-preference option contracts for set S(i) that are satisfied by items of type t

21. The method of claim 15, wherein said providing a resource data represents the data as a(t) being the number of units of type t that are available, and wherein said instantiating and said feasibility-determining comprise computing the following algorithm:
S(1), S(2) . . . S(R) are each a buyer-preference option set or a seller-preference option set of R different of the item types,
q^{BP}(i) is the quantity of buyer-preference option contracts for set S(I),
q^{SP}(i) is the number of seller-preference option contracts for set S(i), and
for every s(i,t) set of integers satisfying the following equations:
$$\begin{matrix}{\sum }_{i ∋ / ∈ S ( i )}^{ } s ( i , t ) \leq a ( t ) for all t \\ {\sum }_{i ∋ / ∈ S ( i )}^{ } s ( i , t ) = {q}^{BP} ( i ) \\ s ( i , t ) \geq 0 , integer\end{matrix}$$
there exists a set of integers solving the following equations:
$$\begin{matrix}{\sum }_{i ∋ / ∈ S ( i )}^{ } {y}^{SP} ( i , t ) \leq a ( t ) - {\sum }_{i}^{ } {\sum }_{t ∈ S ( i )}^{ } s ( i , t ) for all t \\ {\sum }_{i ∋ / ∈ S ( i )}^{ } {y}^{SP} ( i , t ) = {q}^{SP} ( i ) \\ {y}^{SP} ( i , t ) \geq 0 , integer\end{matrix}$$
where
y^{SP}(i,t) is the number of seller-preference option contracts for set S(i) that are satisfied by a(t) for type t.
